(19) United States
(12) Patent Application Publication
(10) Pub. No.: US 2014/0379915 A1
(43) Pub. Date: Dec. 25, 2014

(54) CLOUD BASED DYNAMIC ACCESS CONTROL LIST MANAGEMENT ARCHITECTURE

(71) Applicant: CISCO TECHNOLOGY, INC., SAN JOSE, CA (US)

(72) Inventors: Ling YANG, Eastwood (AU); Yijie XIE, Marsfield (AU)

(73) Assignee: CISCO TECHNOLOGY, INC., SAN JOSE, CA (US)

(21) Appl. No.: 14/084,074

(22) Filed: Nov. 19, 2013

Related U.S. Application Data
(60) Provisional application No. 61/836,960, filed on Jun. 19, 2013.

(51) Int. Cl. H04L 29/08

(52) U.S. Cl. CPC H04L 29/08009
USPC 709/225

(57) ABSTRACT

In one embodiment, a method comprises receiving, by a router, network traffic having been generated by one or more client devices; parsing information from the network traffic; forwarding the information associated with the network traffic to an access control list management server; receiving, from the access control list management server, policy values describing an access control list policy associated with the network traffic; and implementing the policy values for enforcement of the access control list policy by the router.

This application claims priority from Provisional Application No. 61/836,960, filed Jun. 19, 2013.

### TECHNICAL FIELD

The present disclosure generally relates to management of access control lists (ACLs) and networked computer systems.

### BACKGROUND

This section describes approaches that could be employed, but are not necessarily approaches that have been previously conceived or employed. Hence, unless explicitly specified otherwise, any approaches described in this section are not prior art to the claims in this application, and any approaches described in this section are not admitted to be prior art by inclusion in this section.

Management of access control lists (ACL) invariably causes numerous difficulties for large enterprise-sized networks. Network administrators are facing large amount of ACL management requirements per device. Hence, network administrators do not have an effective way to configure, manage, or optimize management of access control lists across a large network. Hence, the number of access control lists size grow exponentially; hence, access control lists quickly become “out of control” and unmanageable for network administrators. Attempts at centralized management of access control lists do not address the needs of enabling network administrators attempting to efficiently manage the large numbers of access control lists, especially since prior attempts still have required administrators to manually configure the access control lists.

### BRIEF DESCRIPTION OF THE DRAWINGS

Reference is made to the attached drawings, wherein elements having the same reference numeral designations represent like elements throughout and wherein:

FIG. 1 illustrates an example system having an apparatus configured for creating and managing access control lists for a router, according to an example embodiment.

FIG. 2 illustrates an example router configured for sending traffic information to a management server and receiving access control list information based on the traffic information, according to an example embodiment.

FIG. 3 illustrates an example management server configured for receiving traffic information from a router in response to generating access control list information for implementation in the router, according to an example embodiment.

FIG. 4 illustrates in further detail the packet analysis engine (PAE) of FIG. 3, according to an example embodiment.

FIG. 5 illustrates in further detail the rule matching of FIG. 3, according to an example embodiment.

FIG. 6 illustrates an example method of a router requesting and receiving an access control list policy for network traffic having been received by the router, according to an example embodiment.

FIG. 7 illustrates an example method of a management server determining an access control list policy requested by a router, according to an example embodiment.

### DESCRIPTION OF EXAMPLE EMBODIMENTS

### Overview

In one embodiment, a method comprises receiving, by a router, network traffic having been generated by one or more client devices; parsing information from the network traffic; forwarding the information associated with the network traffic to an access control list management server; receiving, from the access control list management server, policy values describing an access control list policy associated with the network traffic; and implementing the policy values for enforcement of the access control list policy by the router.

In another embodiment, a method comprises receiving, from a router, information associated with network traffic having been received by the router; determining an access control list policy for the network traffic based on the information; and sending to the router policy values describing the access control list policy, for implementation and enforcement of the access control list policy by the router.

### DETAILED DESCRIPTION

Particular embodiments use a cloud based architecture to dynamically create/delete/manage access control lists (ACLs) that manage admission control policies for network traffic generated by user devices (e.g., personal computers, intelligent tablet devices, intelligent mobile phones, etc.), and also generate ACL recommendations for network administrators. In particular, example embodiments enable dynamic generation of access control lists by a centralized management server, based on the centralized management server obtaining information associated with network traffic having been received by a router. The centralized management server can determine an access control list policy for the network traffic based on the information and prescribed policies available to the centralized management server, and can dynamically generate policy values that describe the access control list policy, enabling the router to implement and enforce the access control list policy. If necessary, the centralized management server also can generate a proposed access control list policy, and submit a recommendation specifying the proposed access control list policy to a network administrator for confirmation.

Hence, the example embodiments enable dynamic creation and management of access control lists based on existing network traffic, eliminating the necessity of manual configuration of network devices (e.g., network switches or network routers) by network administrators.

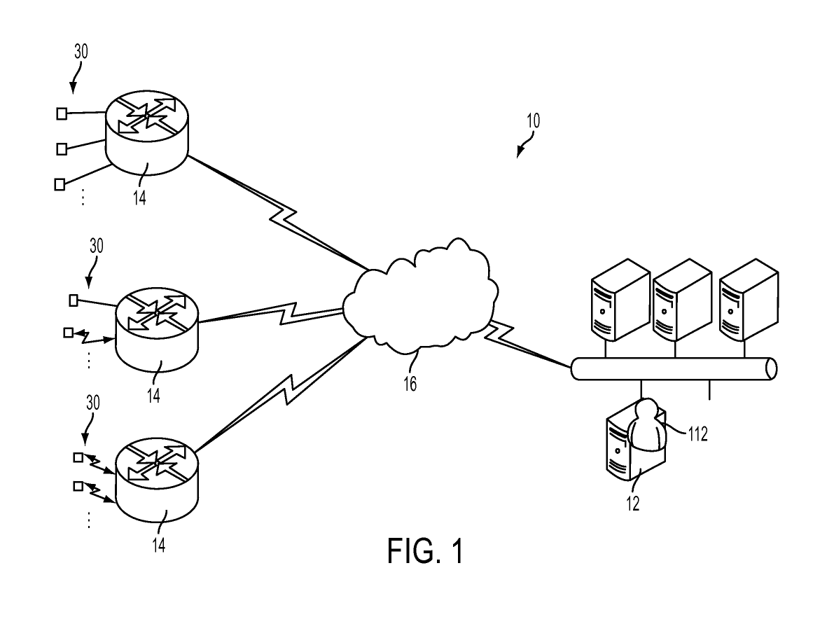

FIG. 1 illustrates an example system 10 having an apparatus 12 for creating and managing access control lists with one or more network routers 14 via a local area network (LAN) and/or wide area network (WAN) 16, according to an example embodiment. Each apparatus 12 and 14 is a physical machine (i.e., hardware device) configured for implementing network communications with other physical machines via the network 16. The wide-area network 16 can be implemented for example as a private wide-area network which can use at least a portion of the Internet.

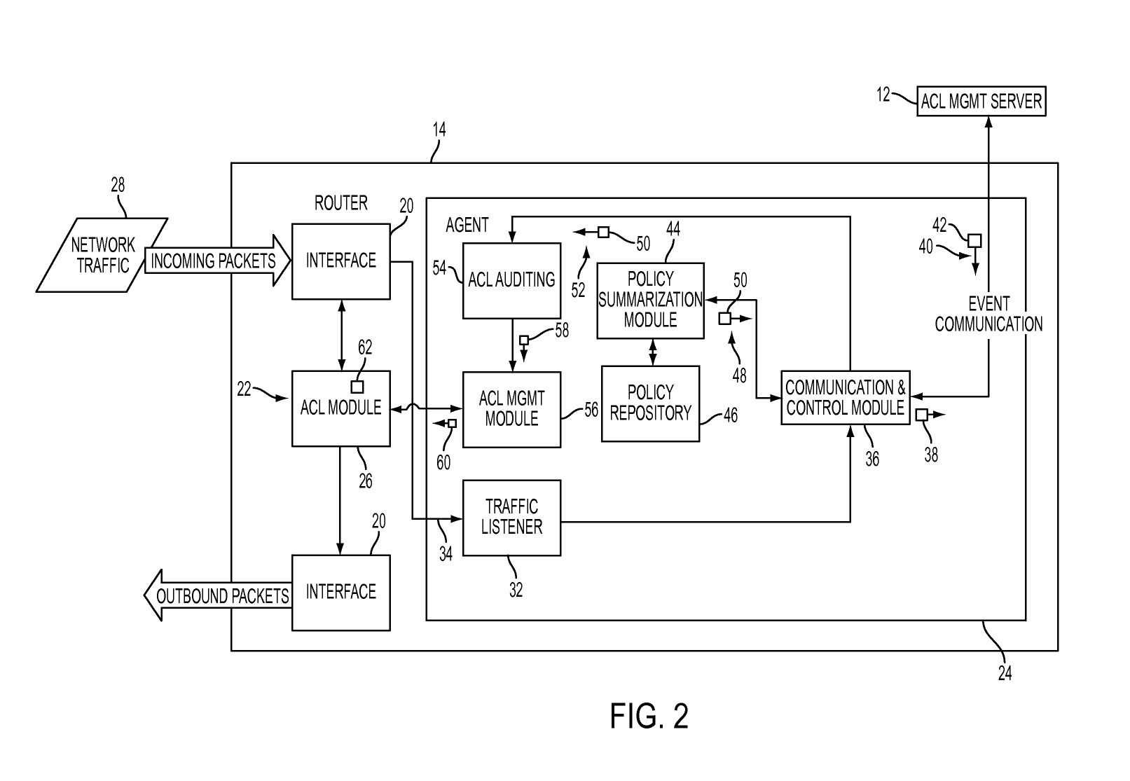

FIG. 2 illustrates an example router 14 configured for sending traffic information to a management server and receiving access control list information based on the traffic information, according to an example embodiment. The router 14 can include one or more network interface circuits 20 and one or more processor circuits 22 that can implement an agent module 24 and an access control list (ACL) module 26.

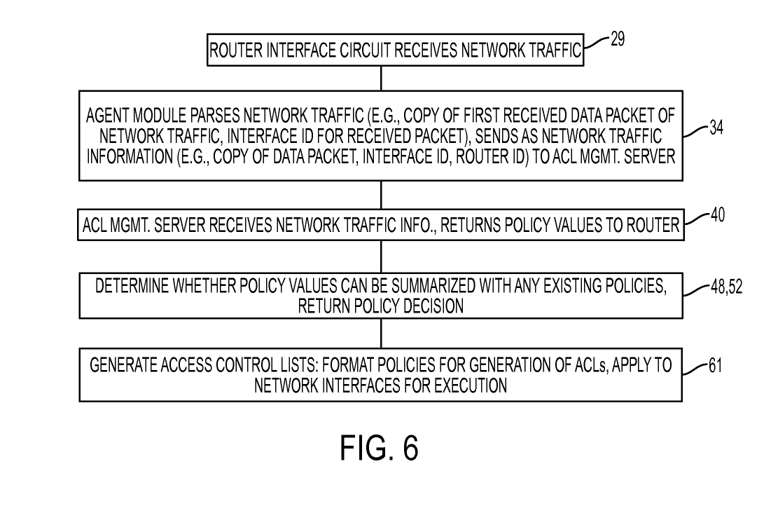

The network interface circuit 20 can be configured for receiving network traffic 28 in operation 29 of FIG. 6 in the form of flows of data packets having been generated by one or more client devices (30 of FIG. 1), for example personal computers, laptops computers, intelligent tablet, intelligent mobile phones, etc. via wired or wireless connections. In response to the network traffic 28 flowing into the network interface circuit 20, the network interface circuit 20 can forward the network traffic 28 to the agent module 24. The agent module 24 can be implemented as an application-specific integrated circuit (ASIC), a software-based executable resource executed by the processor circuit 22, and/or a combination thereof. A traffic listener 32 within the agent module 24 can capture the first packet of the network traffic 28 and identify it with an interface identifier associated with the network interface circuit 20 in operation 34. A communication and control module 36 in the agent module 24 can forward the packet captured by the traffic listener 32 as information 38 to the management server 12 via the wide-area network 16 of FIG. 1; hence, the information 38 sent to the management server 12 can specify the data packet captured by the traffic listener, the interface identifier, and an identifier for the router 12.

As described in further detail below, the centralized ACL management server 12 can return to the communication and control module 36 in operation 40 policy values 42 that describe an access control list policy determined by the ACL management server 12 based on the information 38 from the router 14. A policy summarization module 44 can determine in operation 48 whether the determined network policy as defined by the policy values 42 can be summarized with any existing policy stored in a local policy repository 46, implemented for example as a machine-readable memory circuit. The policy summarization module 44 can return in operation 48 a policy decision 50 to the communication and control module 36, which can forward the policy decision 50 in operation 52 to an ACL auditing module 54. The ACL auditing module 54 can perform auditing operations (e.g., “sanity checks”), and in response cause an ACL management module 56 to format the policies 58. The formatted policies 60 are sent to the ACL module 26 which generates in operation 61 the final access control lists 62. In particular, the ACL module 26 can collect all statistics data on generated access control lists (ACLs) 62. The ACL management module 56 can maintain the life cycle of ACLs 62 based on the statistics data collected by the ACL module 26. The access control lists 62 generated by the ACL module 26 are applied to the inbound and outbound interfaces 20. Network traffic 28 from the interface 20 can be analyzed with respect to the ACL maintained in the ACL module 26: if a given data packet in the network 28 is the first (i.e., initial) packet of a data flow, the data packet can be captured by the traffic listener 32. If the data packet is subsequent to the initial data packet in the data flow, the event of receiving the packet is recorded by the ACL module 26 based on updating ACL statistics associated with the corresponding ACL 62, for example tracking hit count and generating traffic statistics based on the live traffic relative to the ACLs 62. The ACL statistics can be used by the ACL management module 56 to maintain the life cycle of the ACL 62, for example based on placing the ACL 62 in a suspended state after expiration after a prescribed interval (e.g., an idle interval), enabling the ACL 62 to resume if the traffic flow 28 resumes. Note that the ACL management module 56 also can determine based on local routing tables which interface should apply the dynamically generated ACLs 62.

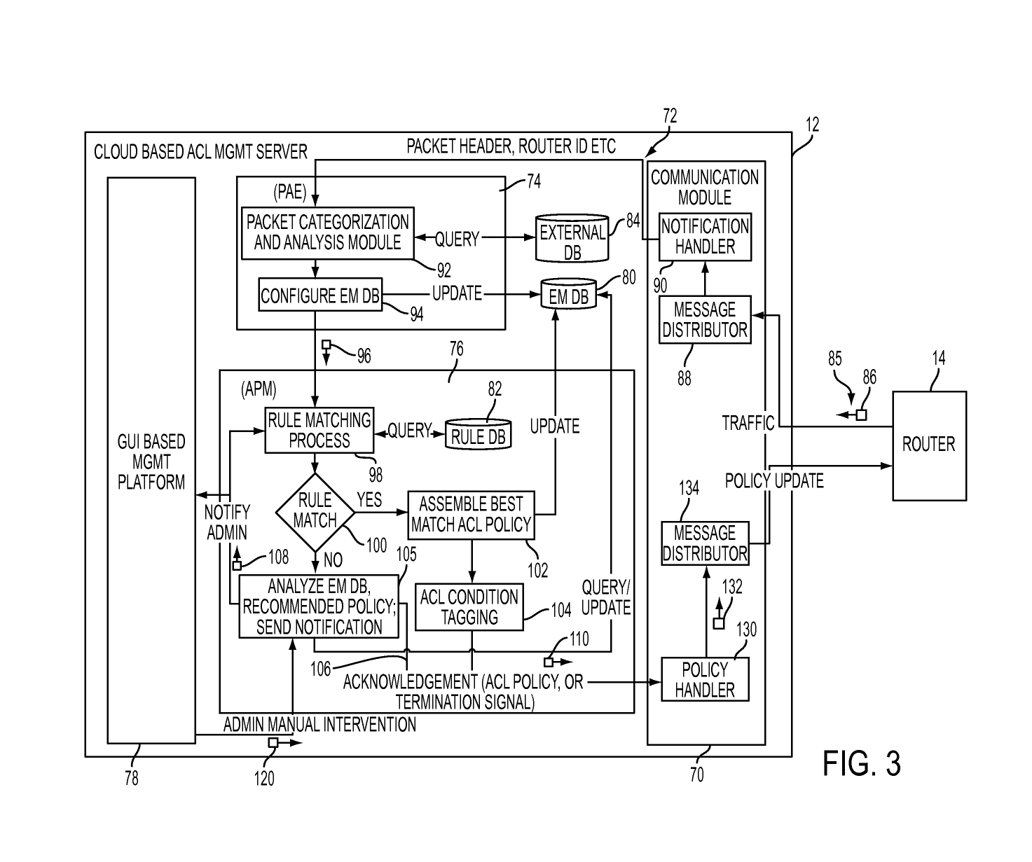

FIG. 3 illustrates an example implementation of a cloud-based access control list (ACL) management server 12, according to an example embodiment. The server 12, implemented for example in a data center providing cloud-based computing services, can include a network interface circuit 70, also referred to as a communication module, and one or more processor circuits 72. The processor circuit 72 can implement a packet analysis engine (PAE) 74, and ACL policy module (APM) 76 and a graphic user interface (GUI) based management platform 78. The server 12 also can access an event management database (EMDB) 80, a rule database 82, and a traffic categorization database 84 which can be implemented as a built-in database or an external third-party database.

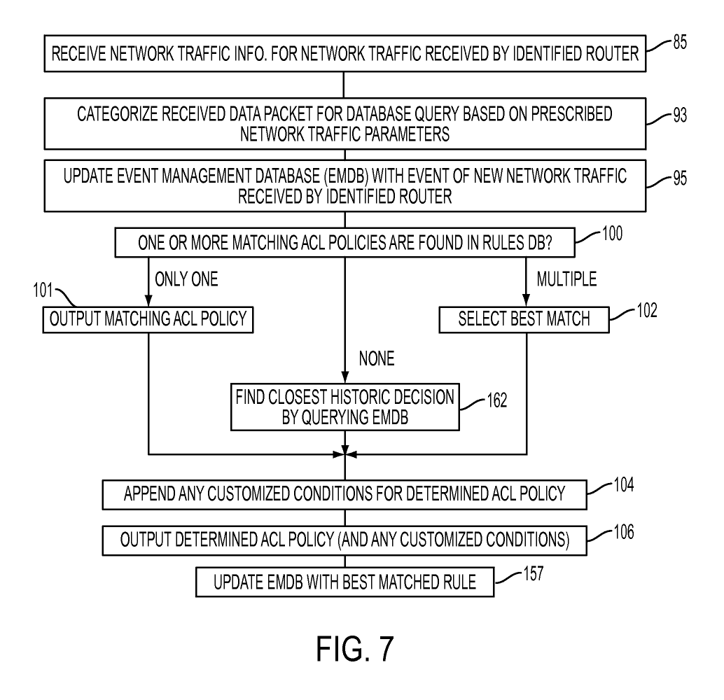

The communication module 70 can receive, from the router 14 in operation 85 of FIG. 7, information 86 associated with network traffic having been received by the router 14: the information 86 can include a copy of a received data packet, a router identifier, and an interface identifier. A message distributor 88 in the communication module 70 can add the information 86 into a message queue (e.g., a first in first out (FIFO) queue), and can send the first available information message 86 to a notification handler 90 in the communication module 70. The notification handler 90 can inform the packet analysis engine module 74 of the network traffic information 86, including packet header, router identifier, interface identifier, etc. A packet categorization and analysis module 92 can analyze the information 86 and disassemble the received data packet, and can either query an external database or internal database 84 in order to categorize the received data packet in operation 93 according to prescribed categorization parameters and network traffic type. The packet analysis engine in operation 94 can format the query result, and update a local event management database (EMDB) 80 in operation 95.

The packet analysis engine 74 can forward the query result 96 to the ACL policy module (APM) 76. A rule matching process 98 in the APM 76 can identify the best access control list policy based on a correlation relative to stored access control list policies; for example, the rule matching process 98 can query the rule database 82 to find a matching access control list policy: if a single ACL policy is found in operation 101, the determined ACL policy 110 can be output in operation 106; if in operation 100 multiple matches are found, the APM 76 can select the highest confidence policy (best match) in operation 102, and append in operation 104 any customized conditions that are needed.

If in operation 100 the matching process returns a “null” (i.e., no matches are found), the event management database 80 can be queried by the APM 76 to identify the closest historic decision in operation 162 (described below). The APM 76 can send any acknowledgment or deny message, or send the determined ACL policy 110 in operation 106 to the policy handler 130. A notification 108 also can be sent by the APM 76 to the management platform 78, enabling a network administrator (112 of FIG. 1) to approve, reject, or modify the recommendation generated by the APM 76.

The APM 76 can update the EMDB 80 in response to the administrator action 120, such that the same flow can be allowed for subsequent instances of the same network traffic 28 if the administrator approves the recommendation.

The policy handler 130 in the communication module 70 can format the policy decision 110 into router policy values 132 describing the access control list policy 110, wherein the message distributor 134 can send the message containing the router policy values 132 to the router 14.

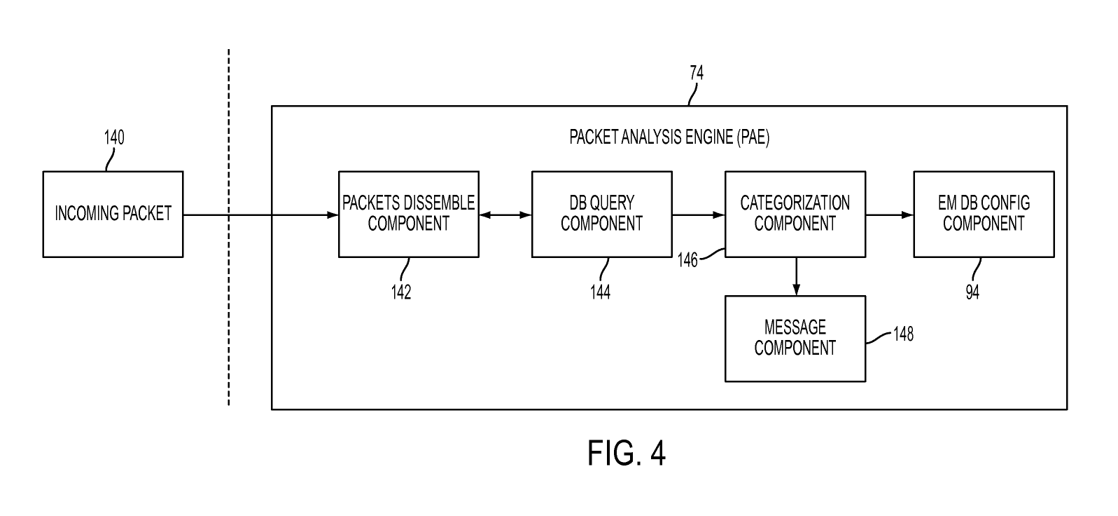

FIG. 4 illustrates in further detail the packet analysis engine (PAE) 74 of FIG. 3, according to an example embodiment. An incoming packet 140 is disassembled by a packets disassemble component 142 which can retrieve basic information such as Internet protocol (IP) addresses including source address, destination address, source and destination TCP/UDP ports, timestamps, etc. A database query component 144 can format the information retrieved by the packets disassemble component 142 in order to query the database 84. The database can be any type of database, for example a commercially available Cisco Intrusion Prevention System (IPS) database, a wireshark database as described at the website address “http://www.wireshark.org/”, or any external database which can help categorize packets. Hence, based on the traffic received from the network, the server 12 can leverage external databases such as a Cisco IPS database, wireshark traffic database, etc., to categorize network traffic; as described in further detail below, the categorization with the highest confidence value “wins” the database query and is returned as the query results. The categorization component 146 can format the query results, enabling updating the EMDB database 80 of FIG. 3 by the configuration component 94. The message component 148 can forward the query results to the APM 76 for further analysis.

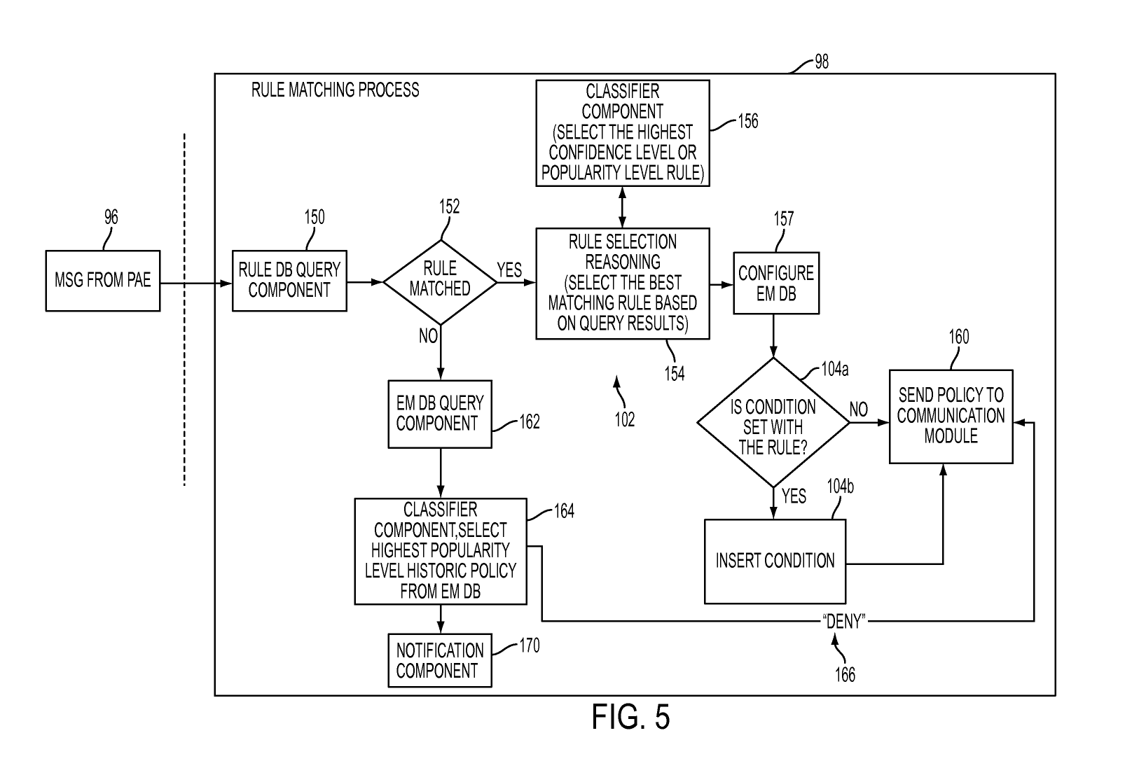

FIG. 5 illustrates in further detail the rule matching process 98 of FIG. 3, according to an example embodiment. In response to receiving the message 96 from the PAE 74, the rule matching process 98 can query in operation 150 the rules database 82 of FIG. 3: if in operation 152 there is a rule match, all the matched rules are returned to module 102, which can comprise a rules selection reasoning module 154 and a classifier module 156. The rule selection reasoning module 154 can engage the classifier module 156 to calculate a confidence level of each matched rule, or the popularity level of each matched rule. Based on the traffic pattern seen from the network by the router 14, the server 12 can maintain the EMDB 80 and track the usage of each policy; hence, the ACL server 12 can calculate and maintain the popularity value of each policy. The popularity value of each policy can thus expedite the policy selection process. The highest level rule will be selected as the best matched rule and sent to configure the EMDB 80 in operation 157. If in operation 104a a condition is set with the chosen rule (e.g., “if ACL has no hit counts for 30 days, then delete”), then append the condition value in operation 104b to the best matched rule and send in operation 160 the policy 110 to the communication module 70.

If in operation 152 the matched rule query returns a “null”, then in operation 162 the EMDB 80 can be queried in an attempt to return the highest popularity level rule as a system recommendation in operation 164 (a “deny” 166 also can be sent to the communication module 70 to acknowledge the request). A notification 170 also can be sent to the admin interface 78 regarding the recommended rule, enabling the network administrator 112 to manually approve, deny, or modify the rule. The feedback 120 from the network administrator 112 will be updated to the EMDB database 80 for future reference.

Hence, the example embodiments implement learning in the 14 router to generate statistics, and summarize the traffic into different patterns, and then forward the packet to the central server. The central server can then determine an ACL decision based on policies, and push the ACL decision to the router; hence, ACL management for a large number of network devices can be managed in a scalable manner.

Any of the disclosed circuits of machines 12 or 14 (including the network interface circuit, any memory circuit, and any processor circuit, and their associated components) can be implemented in multiple forms. Example implementations of the disclosed circuits include hardware logic that is implemented in a logic array such as a programmable logic array (PLA), a field programmable gate array (FPGA), or by mask programming of integrated circuits such as an application-specific integrated circuit (ASIC). Any of these circuits also can be implemented using a software-based executable resource that is executed by a corresponding internal processor circuit such as a microprocessor circuit (not shown) and implemented using one or more integrated circuits, where execution of executable code stored in an internal memory circuit causes the integrated circuit(s) implementing the processor circuit to store application state variables in processor memory, creating an executable application resource (e.g., an application instance) that performs the operations of the circuit as described herein. Hence, use of the term “circuit” in this specification refers to both a hardware-based circuit implemented using one or more integrated circuits and that includes logic for performing the described operations, or a software-based circuit that includes a processor circuit (implemented using one or more integrated circuits), the processor circuit including a reserved portion of processor memory for storage of application state data and application variables that are modified by execution of the executable code by a processor circuit. A memory circuit can be implemented, for example, using a non-volatile memory such as a programmable read only memory (PROM) or an EPROM, and/or a volatile memory such as a DRAM, etc.

Further, any reference to “outputting a message” or “outputting a packet” (or the like) can be implemented based on creating the message/packet in the form of a data structure and storing that data structure in a tangible memory medium in the disclosed apparatus (e.g., in a transmit buffer). Any reference to “outputting a message” or “outputting a packet” (or the like) also can include electrically transmitting (e.g., via wired electric current or wireless electric field, as appropriate) the message/packet stored in the tangible memory medium to another network node via a communications medium (e.g., a wired or wireless link, as appropriate) (optical transmission also can be used, as appropriate). Similarly, any reference to “receiving a message” or “receiving a packet” (or the like) can be implemented based on the disclosed apparatus detecting the electrical (or optical) transmission of the message/packet on the communications medium, and storing the detected transmission as a data structure in a tangible memory medium in the disclosed apparatus (e.g., in a receive buffer). Also note that any memory circuit can be implemented dynamically by the processor circuit, for example based on memory address assignment and partitioning executed by the processor circuit.

The operations described in any of the Figures can be implemented as executable code stored on a computer or machine readable non-transitory tangible storage medium (e.g., floppy disk, hard disk, ROM, EEPROM, nonvolatile RAM, CD-ROM, etc.) that are completed based on execution of the code by a processor circuit implemented using one or more integrated circuits; the operations described herein also can be implemented as executable logic that is encoded in one or more non-transitory tangible media for execution (e.g., programmable logic arrays or devices, field programmable gate arrays, programmable array logic, application specific integrated circuits, etc.).

In addition, the operations described with respect to any of the Figures can be performed in any suitable order, or at least some of the operations in parallel. Execution of the operations as described herein is by way of illustration only; as such, the operations do not necessarily need to be executed by the machine-based hardware components as described herein; to the contrary, other machine-based hardware components can be used to execute the disclosed operations in any appropriate order, or at least some of the operations in parallel.

While the example embodiments in the present disclosure have been described in connection with what is presently considered to be the best mode for carrying out the subject matter specified in the appended claims, it is to be understood that the example embodiments are only illustrative, and are not to restrict the subject matter specified in the appended claims.

What is claimed is:

1. A method comprising:
receiving, by a router, network traffic having been generated by one or more client devices;
parsing information from the network traffic;
forwarding the information associated with the network traffic to an access control list management server;
receiving, from the access control list management server, policy values describing an access control list policy associated with the network traffic; and
implementing the policy values for enforcement of the access control list policy by the router.

2. The method of claim 1, wherein the parsing includes capturing a data packet from the network traffic, the forwarding including specifying, within the information, the data packet, an interface identifier associated with reception of the network traffic, and a router identifier.

3. The method of claim 1, wherein the implementing includes:
determining whether the policy values can be summarized with existing policies, and generating a corresponding policy decision; and
generating access control lists, based on the policy decision, for execution by network interfaces in the router.

4. An apparatus comprising:
a network interface circuit configured for receiving network traffic having been generated by one or more client devices; and
a processor circuit configured for:
parsing information from the network traffic, and forwarding the information associated with the network traffic to an access control list management server,
receiving, from the access control list management server, policy values describing an access control list policy associated with the network traffic, and
implementing the policy values within the network interface circuit for enforcement of the access control list policy.

5. The apparatus of claim 4, wherein the parsing includes capturing a data packet from the network traffic, the forwarding including specifying, within the information, the data packet, an interface identifier associated with reception of the network traffic, and a router identifier.

6. The apparatus of claim 4, wherein the implementing includes:
determining whether the policy values can be summarized with existing policies, and generating a corresponding policy decision; and
generating access control lists, based on the policy decision, for execution by network interfaces in the router.

7. Logic encoded in one or more non-transitory tangible media for execution by a machine and when executed by the machine operable for:
receiving, by the machine, network traffic having been generated by one or more client devices;
parsing information from the network traffic;
forwarding the information associated with the network traffic to an access control list management server;
receiving, from the access control list management server, policy values describing an access control list policy associated with the network traffic; and
implementing the policy values for enforcement of the access control list policy by the machine.

8. The logic of claim 7, wherein the parsing includes capturing a data packet from the network traffic, the forwarding including specifying, within the information, the data packet, an interface identifier associated with reception of the network traffic, and a router identifier.

9. The logic of claim 7, wherein the implementing includes:
determining whether the policy values can be summarized with existing policies, and generating a corresponding policy decision; and
generating access control lists, based on the policy decision, for execution by network interfaces in the router.

10. A method comprising:
receiving, from a router, information associated with network traffic having been received by the router;
determining an access control list policy for the network traffic based on the information; and
sending to the router policy values describing the access control list policy, for implementation and enforcement of the access control list policy by the router.

11. The method of claim 10, wherein the determining includes:
categorizing the network traffic according to network traffic type; and
identifying the access control list policy for the network traffic according to network traffic type, based on a correlation relative to stored access control list policies.

12. The method of claim 11, wherein the identifying includes:
determining whether a best match exists based on determining whether one or more matching access control list policies is located for the network traffic according to the network traffic type;
if no matching access control list policies are located, determining a closest historic decision for an access control list as the access control list policy for the router, based on sending a query to an event management database configured for storing events and associated policy decisions.

13. The method of claim 12, wherein determining a best match includes applying at least one of a rule selection reasoning, a highest confidence level, or a popularity level rule for choosing the access control list policy if multiple matching access control list policies are located for the network traffic.

14. The method of claim 10, further comprising:
notifying an event management database of the network traffic having been received by the router, the event management database storing historical policy decisions for respective network traffic events;
the determining including determining from the event management database if a closest historic decision is available for the network traffic having been received by the router, based on a determined absence of a matching access control list policy in a rules database configured for storing rules for access control list policies
the determining further including notifying the event management database of the access control list policy determined for the network traffic having been received by the router.

15. Logic encoded in one or more non-transitory tangible media for execution by a machine and when executed by the machine operable for:
receiving, from a router, information associated with network traffic having been received by the router;
determining an access control list policy for the network traffic based on the information; and
sending to the router policy values describing the access control list policy, for implementation and enforcement of the access control list policy by the router.

16. The logic of claim 15, wherein the determining includes:
categorizing the network traffic according to network traffic type,
identifying the access control list policy for the network traffic according to network traffic type, based on a correlation relative to stored access control list policies.

17. The logic of claim 16, wherein the identifying includes:
determining whether a best match exists based on determining whether one or more matching access control list policies is located for the network traffic according to the network traffic type;
if no matching access control list policies are located, determining a closest historic decision for an access control list as the access control list policy for the router, based on sending a query to an event management database configured for storing events and associated policy decisions.

18. The logic of claim 17, wherein determining a best match includes applying at least one of a rule selection reasoning, a highest confidence level, or a popularity level rule for choosing the access control list policy if multiple matching access control list policies are located for the network traffic.

19. The logic of claim 15, further operable for:
notifying an event management database of the network traffic having been received by the router, the event management database storing historical policy decisions for respective network traffic events;
the determining further including notifying the event management database of the access control list policy determined for the network traffic having been received by the router.

20. The logic of claim 19, wherein the determining further includes including determining from the event management database if a closest historic decision is available for the network traffic having been received by the router, based on a determined absence of a matching access control list policy in a rules database configured for storing rules for access control list policies.
